(19) United States
(12) Patent Application Publication
(10) Pub. No.: US 2004/0061781 A1
(43) Pub. Date: Apr. 1, 2004

(54) Method of digital video surveillance utilizing threshold detection and coordinate tracking

(75) Inventors: Darius K. Fennell, Rochester, NY (US); Thomas M. Stephany, Churchville, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/245,857

(22) Filed: Sep. 17, 2002

(51) Int. Cl. H04N 7/18

(52) U.S. Cl. 348/169; 382/103; 348/152

(57) ABSTRACT

A security system for tracking suspicious characteristics, the system includes first and second cameras each for monitoring and capturing images in a predefined area; and a computer electrically connected to the each camera and which computer is programmed to identify one or more movements that exceeds a predetermined threshold that is predefined as suspicious movement; wherein, when suspicious movement is detected by the first camera, the computer communicates to the second camera coordinates at which the suspicious movement will enter the predefined area of the second camera so that tracking is maintained within a larger predefined area.

### FIELD OF THE INVENTION

The invention relates generally to the field of video surveillance and, more particularly, to such video surveillance which coordinates two or more video cameras with a programmed computer so that surveillance is automated and so that the area of security surveillance is increased without any loss of effectiveness.

### BACKGROUND OF THE INVENTION

The proliferation of video surveillance and its various uses is well known to a large percentage of the general populace. The presence of cameras in malls, airports, businesses, and even on the street has familiarized people with the fact that video surveillance of some kind is regularly used. The function of such monitoring is both to prevent and identify crimes and to record activities at a vast number of locations. Since the identification of suspicious activity with such equipment is subject to the attention and lapses thereof of the monitoring personnel, these video systems are often more effective at registering a singular blatant act, but are much less effective at identifying a single piece of suspicious activity, or a series of suspicious activities over a long period of time. Given these times of terrorist activity, random and/or instantaneous acts that need intervention by proper authorities at a moment's notice, improvements are both more desirable and valuable.

U.S. Pat. No. 5,969,755 and U.S. Pat. No. 6,424,370 B1 disclose a motion based detection system and method that include providing a set of indexes derived from motion video. These indexes provide means to detect motion. Through the addition of extra processing, events of interest such as appearance/disappearance, deposit/removal, entrance/exit and motion/rest can also be determined. However, these above prior art patents lack fundamental advantages that are necessary to build a successful monitoring system which specifically targets suspicious activity.

Consequently, a need exists to prevent random and instantaneous acts of terrorism by determining which activities by individuals or groups thereof, are considered suspicious, and upon determination, provide a way to automatically track those movements or activities without need for manual intervention by security personnel.

### SUMMARY OF THE INVENTION

The invention herein discloses significant advantages over present prior art. First, the present invention permits the placement of a predetermined threshold value on what may be considered suspicious activity, and can therefore initiate formal tracking of an event based upon that preset threshold. Secondly, the present invention can allow a predetermined time limit for the aforementioned formal tracking. This predetermined time limit is initiated when the formally tracked suspicious activity falls below the predetermined threshold. Formal tracking will continue for the predetermined time limit, and lacking any further suspicious activity, record the last tracked frame as a still picture. The system will then return to random search activity for suspicious movement, using the predetermined threshold criteria. Thirdly, the present invention uses a coordinate based tracking system that allows the suspicious events to be transferable from camera to camera. Since cameras of the present invention have some zonal overlap, these cameras have the ability to transfer formal suspicious activity tracking from zone to zone or more specifically from spot to spot. These system attributes, along with the ability to signal the attention of distracted or inattentive security personnel to a suspicious event, create significant advantages over the prior art for the tracking of terrorist activities.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention has the following advantage of preventing random acts of terrorism from being completed. It also provides means to automatically track suspicious movement from one monitored area to another.

### BRIEF DESCRIPTION OF THE DRAWINGS

FIG. 1 is a top view of an area to be monitored;

FIG. 2 is a top view drawing of the area to be monitored and visually details the X, Y coordinate pattern which, in part, facilitates camera tracking from zone to zone;

FIG. 3 is a side view drawing of the area needing to be monitored visually details the Z coordinate pattern that in part facilitates camera tracking from zone to zone; and

FIG. 4 details a flowchart detailing the tracking process of suspicious activity.

### DETAILED DESCRIPTION OF THE INVENTION

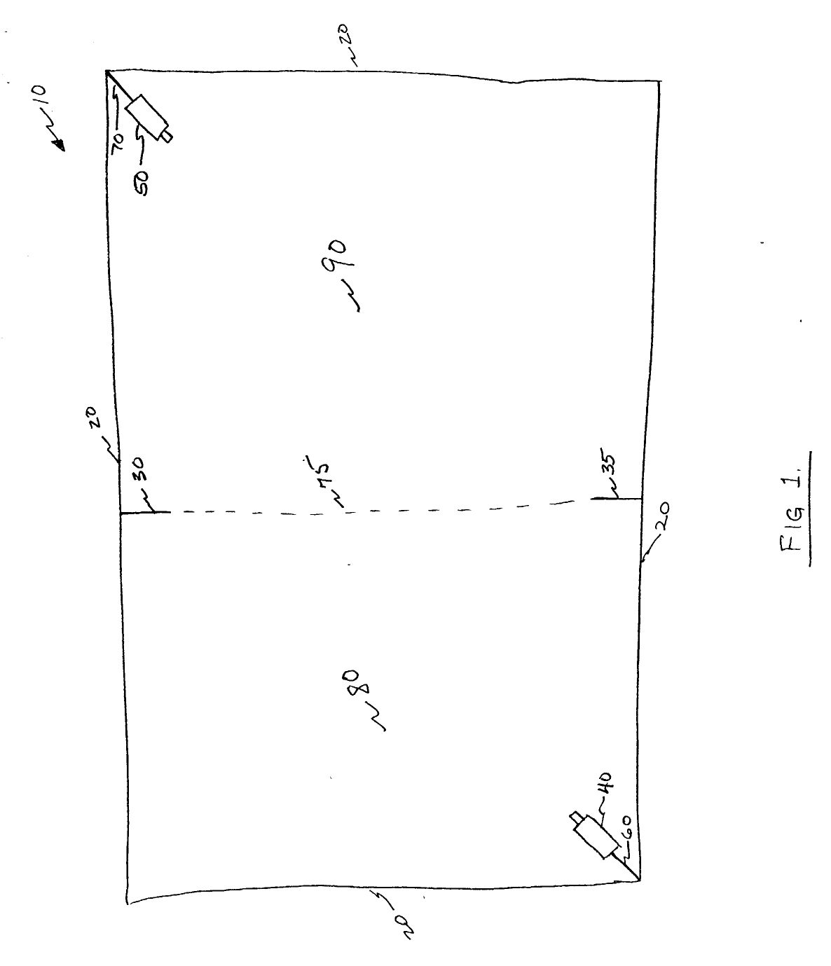

Referring to FIG. 1, there is a diagram of the security system of the present invention. A top view of a general area 10 consists of perimeter walls 20, a first partition 30 and a second partition 35. A first camera 40 and a second camera 50 are securely mounted upon perimeter wall 20. First camera 40 covers first monitor zone 80, and second camera 50 covers second monitor zone 90 of general area 10, so that suspicious activities cannot go undetected, and continuous and overlapping camera coverage is achieved. Monitoring separation between first monitor zone 80 and second monitor zone 90 is shown by dashed line 75. Additionally a first 2-axis control member 60 is attached to first camera 40, and a second 2-axis control member 70 is attached to a second camera 50.

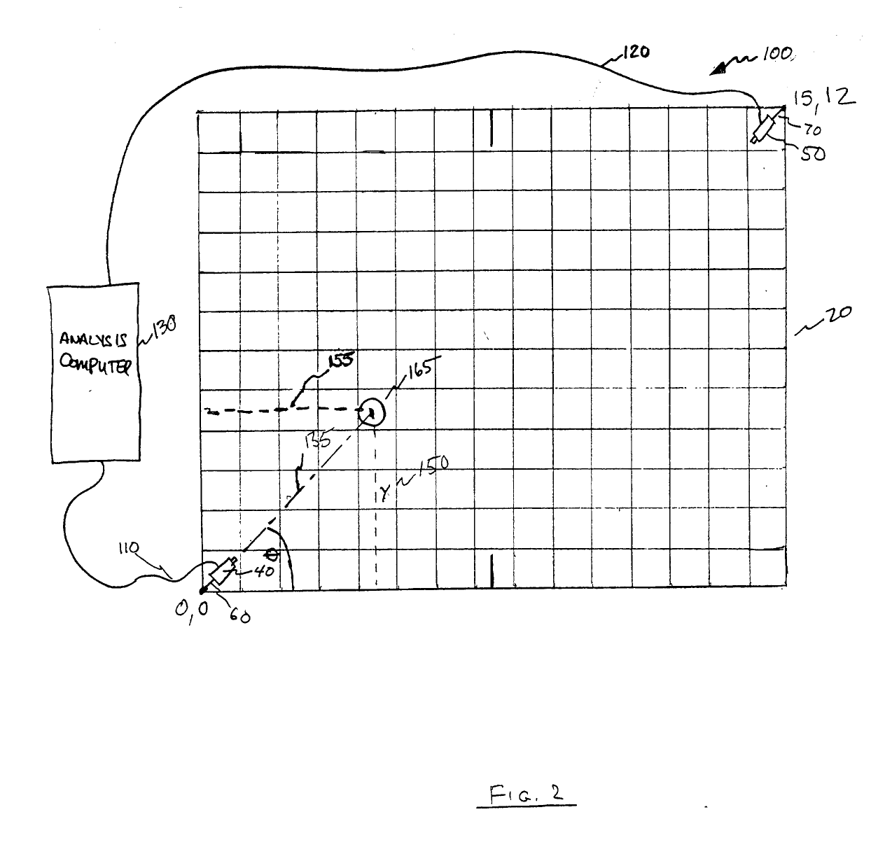

Referring now to FIG. 2., detailed is a top view 100 of general area 10 (from FIG. 1). First camera 40 which is attached to first 2-axis control member 60 is capturing video information for analysis from first monitor zone 80, and first 2-axis control member 60 is both moving first camera 40 and gathering position data from first camera 40 for conversion to X, Y position data. Additionally, second camera 50 which is attached to second 2-axis control member 70, is capturing video information for analysis from second monitor zone 90, while second 2-axis control member 70 is both moving second camera 50 and gathering position data from second camera 50 for conversion to X, Y position data. First data cable 110 is attached to first camera 40 and second data cable 120 is attached to second camera 50, and sends raw data to be processed to analysis computer 130. The raw data is then used to determine if a predefined threshold is broken. An example of such for motion is when a change in positional data for a subject being tracked is high enough above the predefined threshold to indicate that the subject is sprinting. For example, using change detection, tracking changes from one frame to the next can be accomplished. This is accomplished by a Baysian Classifier which includes a plurality of motion detection data. By comparing data from a particular frame of interest to information stored in the database of the Baysian Classifier, a threshold for determining suspicious activities can be determined. One skilled in the art may vary the threshold depending on the environment of the captured images. If a camera detects suspicious activity, in this case first camera 40, the location of the suspect activity needs to be precisely located for tracking. Additionally, if the suspect activity moves from first monitor zone 80 to second monitor zone 90, X, Y, and now Z data must be determined for first camera 40 to pass the suspect activity from first monitor zone 80 to second camera 50 and second monitor zone 90.

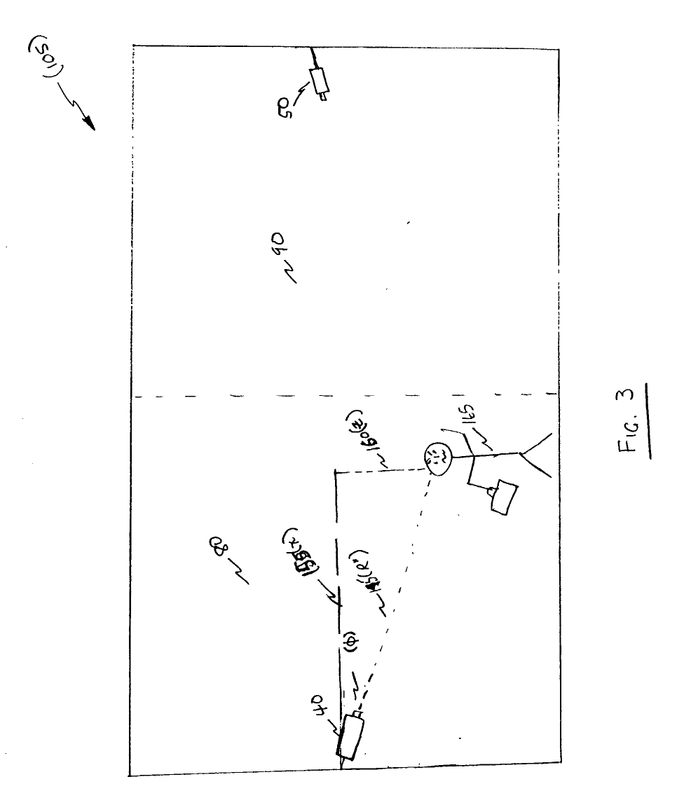

Referring now to FIG. 3, detailed is a side view 105, comprised of first monitor zone 80 and monitored by first camera 40, and second monitor zone 90 that is monitored by second camera 50. In order for suspicious activity to be efficiently tracked from one zone to the next, it is required to have accurate X, Y, and Z data for a first camera monitoring within a first zone to pass that suspicious activity to a second camera monitoring within a second zone.

To calculate the X, Y, and Z data, components from the X-Y axis and X-Z axis must be combined. Because of an inability to see 3D in perspective 2D views, both axes show only an apparent camera to activity distance. From FIG. 2, which is a top view 100, there is a first apparent distance R′ 135 and from FIG. 3 there is a side view of a second apparent distance R″ 145. Additionally in FIG. 2, a first dashed line 155 that is the X component, sets a right angle to the perimeter wall 20. The second dashed line 150 that is also the Y component sets a perpendicular right angle to first dashed line 155. Referring next to FIG. 3, suspicious movement is exhibited by a subject 165 represented in the drawing. The position of subject 165 in the side view 105 is determined by the derivation of the X component 155, and the Z component 160, using the R″ component 145, and the Y component 150 from FIG. 2.

To derive an accurate X, Y, and Z position, the following equations are used:

X=R′ cos θ

Y=R′ sin θ

Z=R″ sin φ

X=R″ cos φ

Where θ and φ are known from first and second two axis control members 60 and 70, and R represents the actual focus distance from a first camera 40 or a second camera 50 to any suspicious activity. Using the Pythagorean Theorem, which is a fifth equation, the ability to solve for the five unknowns with the above five equations allows the derivation of the following:

$$X = \frac{R cos φ}{\sqrt{( \frac{cos φ}{cos θ} ) \hat{} 2 + ( sin θ ) \hat{} 2}}$$

$$Y = \frac{R tan θ cos φ}{\sqrt{( \frac{cos φ}{cos θ} ) \hat{} 2 + ( sin θ ) \hat{} 2}}$$

$$Z = \frac{R sin φ}{\sqrt{( \frac{cos φ}{cos θ} ) \hat{} 2 + ( sin θ ) \hat{} 2}}$$

Referring back to FIG. 3, since accurate X, Y, and Z dimensions are thus easily calculated and easily obtained suspicious subject movements can be passed from first monitor zone 80 to second monitor zone 90 by analysis computer 130 (from FIG. 2.). It must be noted at this point that this ability to pass camera tracking automatically from one zone to another can be expanded to multiple zones and multiple areas such as buildings, airports and a multiplicity of inside and outside spaces.

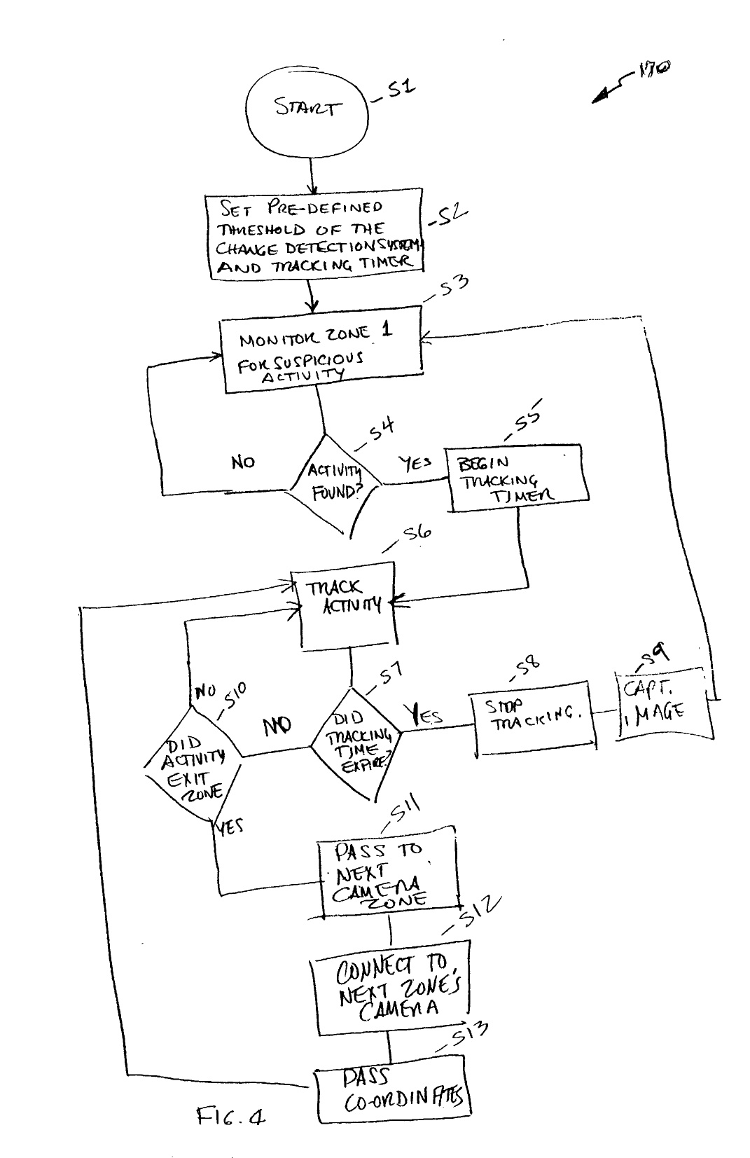

FIG. 4, is a software flowchart 170 of an activity monitoring system. The system starts S1, and then proceeds to set a pre-defined threshold of the change detection and tracking timer S2. This setting is used to monitor a first zone for suspicious movement S3. If activity is detected S4, a tracking timer S5 is started. If no activity is detected S4, flow is redirected back to monitor a first zone for suspicious movement S3. Referring back to begin tracking timer S5, activity is tracked S6. If tracking time expires S7, tracking is stopped S8, and an image is captured S9, and flow is redirected to monitor a first zone for suspicious movement S3. Those skilled in the art will readily recognize that the image may be either a digital image or a photographic image. If tracking time S7 did not expire, flow is directed to S10, did activity exit zone? If no, flow is redirected to S6, track activity. If activity did exit the zone S10, flow is directed to pass to next camera zone S11. The next action after passing to S11 is to connect to the next camera zone S12, and then pass position coordinates to that camera S13 to resume tracking activity S6 in another zone to which the suspicious activity has moved. It should be noted at this point that there is no real end to the software operation described above in that the operation is actually an operating loop. Additionally, software operations in adjacent zones are operated in parallel.

The invention has been described with reference to a preferred embodiment. However, it will be appreciated that variations and modifications can be effected by a person of ordinary skill in the art without departing from the scope of the invention.

### PARTS LIST

10 General Area

20 Perimeter Walls

30 First Partition

35 Second Partition

40 First Camera

50 Second Camera

60 First 2-Axis Control Member

70 Second 2-Axis Control Member

76 Dashed Line

80 First Monitor Zone

90 Second Monitor Zone

100 Top View

105 Side View

110 First Data Cable

120 Second Data Cable

130 Analysis Computer

135 First Apparent Distance R′

140 Second Apparent Distance R″

150 Second Dashed Line (Y Component)

155 First Dashed Line (X component)

160 Z Component

165 Subject

170 Software Flow Chart

S1-S13 Software Flow Chart Steps

What is claimed is:

1. A security system for tracking suspicious characteristics, the system comprising:
(a) first and second cameras each for monitoring and capturing images in a predefined area;
(b) a computer electrically connected to the each camera and which computer is programmed to identify one or more movements that exceeds a predetermined threshold that is predefined as suspicious movement; wherein, when suspicious movement is detected by the first camera, the computer communicates to the second camera coordinates at which the suspicious movement will enter the predefined area of the second camera so that tracking is maintained within a larger predefined area.

2. The security system as in claim 1, wherein, when the movement is below the threshold for a predetermined time, the first or second camera currently doing the tracking terminates tracking of the suspicious movement and scans for other movement above the threshold.

3. The security system as in claim 2, wherein either the first or second camera captures an image before scanning for other movement above the threshold.

4. The security system as in claim 1, wherein either or both of the first and second cameras are either digital or analog cameras.

5. The security system as in claim 1, wherein the first or second cameras that captures both digital and film-based images, and a film based image is captured when a predefined timeout tracking period is exceeded.

6. The security system as in claim 1, wherein a position of the suspicious movement is determined by using the Pythagorean:
X=R′ cos θ
Y=R′ sin θ
Z=R″ sin φ
X=R″ cos φ.

7. A method for tracking suspicious characteristics, the method comprising the steps of:
(a) providing first and second cameras each for monitoring and capturing images in a predefined area;
(b) providing a computer electrically connected to the each camera and which computer is programmed to identify one or more movements that exceeds a predetermined threshold that is predefined as suspicious movement; wherein, when suspicious movement is detected by the first camera, the computer communicates to the second camera coordinates at which the suspicious movement will enter the predefined area of the second camera so that tracking is maintained within a larger predefined area.

8. The method as in claim 7 further comprising the step of, when the movement is below the threshold for a predetermined time, terminating tracking of the suspicious movement by the first or second camera currently tracking, and the tracking camera scans for other movement above the threshold.

9. The method as in claim 8 further comprising the step of providing either the first or second camera capturing an image before scanning for other movement above the threshold.

10. The method as in claim 7 further providing the step of providing either or both of the first and second cameras as either digital or analog cameras.

11. The method as in claim 7 further comprising the step of providing the first or second cameras capturing both digital and film-based images, and a film based image is captured when a predefined timeout tracking period is exceeded.
